(19) United States
(12) Patent Application Publication
(10) Pub. No.: US 2026/0125218 A1
(43) Pub. Date: May 7, 2026

(54) METHOD FOR COLLECTING ARTICLES IN STORE, AND STORE

(71) Applicant: C.M.C. S.P.A., CERBARA-CITTA’DI CASTELLO(PG) (IT)

(72) Inventor: Francesco PONTI, CITTA’DI CASTELLO(PG) (IT)

(73) Assignee: C.M.C. S.P.A., CERBARA-CITTA’DI CASTELLO(PG) (IT)

(21) Appl. No.: 19/117,396

(22) PCT Filed: Oct. 3, 2023
(86) PCT No.: PCT/IB2023/059905

§ 371 Date: Apr. 1, 2025

(30) Foreign Application Priority Data
Oct. 3, 2022 (IT) 102022000020298
Jun. 20, 2023 (IT) 102023000012624

(51) Int. Cl. B65G 1/137; B65G 1/127; B65G 47/57

(52) U.S. Cl. CPC B65G 1/137; B65G 1/127; B65G 47/57

(57) ABSTRACT

A method for collecting articles in a store comprising includes steps of: providing a storage unit of articles including an identifier for each container borne on the respective container and a support system which supports the movable containers with respect to the frame according to a closed looped pathway with a collecting zone; providing movement means of the support system; providing displacement means for displacing the frame of the at least a storage unit of articles; recognising the articles; placing the recognised articles in the containers, placing at most one article for each container; associating the identifier to the placed article; receiving a request for a placed article; retrieving the associated identifier; activating the movement means so as to bring the container which carries the retrieved identifier into the collecting point or area of the articles.

### FIELD OF THE INVENTION

The present invention relates to the technical sector concerning logistics, in particular in the management of articles in stores; the term “stores” comprises a variety of situations such as, for example, stores at the service of industrial facilities, stores at the service of sales points and stores at the service of logistics centres.

In greater detail the present invention relates to a method for collecting articles in a store and a store that can satisfy a plurality of functional needs, for example those connected to the known processes known as, according to a terminology widely used in the sector, Inbound Logistics, Dynamic Storage Solution, Automated Feeding, Downstream Logistics and Sortering.

### DESCRIPTION OF THE PRIOR ART

The use is known, for example da EP 1920396 A2, of self-moving or transportable shelving units for temporarily storing various articles, for example in logistics centres where the stored articles are collected, packaged and dispatched. In a common approach, the articles coming from various suppliers are identified and catalogued, for example by means of reading the barcodes, temporarily stored in the shelving units with the assignation, to the article, of a position which is memorised by the store management system, collected on the basis of the memorised position, introduced into a receptacle and then prepared for dispatch. The positions of the articles are often defined with identifying codes, for example with barcodes borne by the shelving units. The receptacle can be used following a plurality of logics, for example for collecting the articles belonging to a same order or for collecting articles belonging to various orders. Numerous methods and systems are known for storing articles and for managing the articles inside the store, many of which have been set out in patent applications.

Generally, on entry the articles are separated out and catalogued with assignation of an identifying code, often associated to other data such as the mass and dimensions thereof.

While the stores that include the automatic collection of articles are widely known, in the case of self-moving or transportable shelving units the collection is made manually and with limited levels of automation or requires types of automation that are expensive, such as, for example, anthropomorphic robots.

The self-moving or transportable shelving units at present available can reach various stations but to each collection or unloading of the articles there corresponds a new identification of the articles. Several identifications are also realised when the transport of the articles between the various stations takes place using transporters, such as belt conveyors; further, the presence of the belt conveyors limits the spaces available for the logistics.

In other words the memorised position is no longer of any use once the article has been collected from the shelving unit; the tracing is removed and there emerges a need to assign and memorise a new position on each displacement of the article, following identification.

EP 3256290 B1, with particular reference to FIGS. 3B and 3C, describes a storage unit of articles of the self-moving or transportable type comprising a frame, containers for articles arranged to form a first and a second column and a movement system of the containers between a first inclined position so as to avoid falling of the articles and a second position inclined towards the ground surface which facilitates the collection by a collection system. The solution of EP 3256290 B1 facilitates the collection but does not facilitate the loading and unloading of the articles in their entirety. Further, the above system has a significant size with respect to the volume of articles stored.

Solutions for the transfer of the articles using storage modules of stackable articles are described in US 2018201445 A1.

### SUMMARY OF THE INVENTION

The present invention intends to obviate one or more drawbacks of the solutions of the prior art.

A first aim is to simplify the management of the articles temporarily stored in stores.

A second aim is to limit or avoid recognition operations of the articles after each displacement of the article.

A further aim of some embodiments is to simplify automatic collection.

These and other aims, which will be obvious to the expert in the sector from a reading of the following text, are attained by means of a method for collecting articles in a store and a store according to the claims.

According to the teachings of the present description, the method comprises steps of:
providing at least a storage unit of articles comprising a frame, containers for articles, an identifier for each container carried by the respective container a support system of the containers which supports the containers so that they are movable with respect to the frame according to a closed looped pathway which has at least a collection point or area of the articles;
providing movement means for moving the support system so as to move the containers with respect to the frame;
providing displacement means for displacing the frame of the at least a storage unit of articles;
providing articles;
recognising the articles;
placing the recognised articles in the containers, placing at most one article for each container;
associating the identifier of the container to the placed article;
receiving a request for a placed article;
recuperating the identifier associated to the requested article;
activating the movement means so as to bring the container which carries the retrieved identifier to a collection point or area of the articles.
According to the teachings of the present description, the store comprises at least a storage unit of articles comprising a frame, containers for articles and an identifier for each container which is borne by the respective container, loading means for loading articles into the containers, displacement means for displacing the at least a storage unit of articles and a store management system comprising recognition means for recognising the articles and reading means for reading the identifiers.
The store management system is configured to associate each article to the identifier of the container than contains it.
Advantageously:
the at least a storage unit of articles comprises a support system of the containers which supports the containers so that they are movable with respect to the frame according to a closed looped pathway;
the store comprises movement means for moving the support system so as to move the containers with respect to the frame;
the store management system controls the loading means and/or the movement means and is configured in such a way that each container contains at most one article.

### BRIEF DESCRIPTION OF THE DRAWINGS

Specific embodiments of the invention will be described in the following part of the present description, according to what is set down in the claims and with the aid of the accompanying figures, in which:

FIG. 1 illustrates a perspective lateral view of an embodiment of a storage unit of articles according to the invention;

FIG. 2 shows a detail of the embodiment of FIG. 1;

FIGS. from 3 to 5 illustrate an automatic loading sequence of the embodiment of FIG. 1;

FIGS. from 6 to 8 illustrate an automatic collecting sequence of the embodiment of FIG. 1;

FIG. 9 illustrates a perspective view of two units or modules of a further embodiment of a storage unit of articles according to the invention;

FIG. 10 is a perspective view of a unit of the embodiment of FIG. 9;

FIGS. 11 and 12 are details of the embodiment of FIG. 9, with some elements not included so as to facilitate understanding of the functional and structural characteristics;

FIG. 13 illustrates a section (without background) of a container of the embodiment of FIG. 9 according to a vertical plane cutting all containers;

FIG. 14 illustrates a perspective view of a unit of the embodiment of FIG. 9 in a first station;

FIG. 15 is a detail from different viewpoint of FIG. 14;

FIG. 16 illustrates a first station of an embodiment of a store according to the invention;

FIG. 17 illustrates a perspective view from above of an embodiment of a store according to the invention;

FIG. 18 illustrates a perspective lateral view of the embodiment of FIG. 17;

FIG. 19 illustrates a schematic view from above of a further embodiment of a store according to the invention;

FIGS. 20 and 21 are schematic lateral views of some embodiments of the storage unit of articles according to the invention;

FIG. 22 is a perspective lateral view of the self-moving base of the storage unit of articles;

FIG. 23 illustrates a detail of storage unit of articles, entirely alike to that of FIG. 1, with the self-moving base of FIG. 22;

FIG. 24 is a perspective view of the self-moving base of FIG. 22, from a different viewpoint.

### DESCRIPTION OF PREFERRED EMBODIMENTS

With reference to the appended figures, reference numeral 100 denotes a store.

The references are reported to facilitate understanding of the invention, but are not intended to limit the scope of the invention.

An embodiment of a method for collecting articles (A) in a store (100) according to the invention comprises steps of:
providing at least a storage unit of articles (1) comprising a frame (2), containers (3) for articles (A), an identifier (4) for each container (3) carried by the respective container (3) and a support system (5) of the containers (3) which supports the containers (3) so that they are movable with respect to the frame (2) according to a closed looped pathway which has at least a collection point or area of the articles (50c);
providing movement means (6) for moving the support system (5) so as to move the containers (3) with respect to the frame (2);
providing displacement means for displacing the frame of the at least a storage unit of articles (1);
providing articles (A);
recognising the articles (A);
placing the recognised articles (A) in the containers (3), placing at most one article for each container (3);
associating the identifier (4) of the container (3) to the placed article (A);
receiving a request for a placed article (A);
retrieving the identifier (4) associated to the requested article (A);
activating the movement means (6) so as to bring the container (3) which carries the retrieved identifier (4) to a collection point or area of the articles (50c).

The association of an identifier (4) of a container (3) to the article (A) facilitates the management of the store (100), due to a unique tracing of the article (A), thus limiting or avoiding the need for further recognition of the article (A).

Further, the automatic collection of articles (A) from the at least a storage unit of articles (1) is facilitated, while maintaining the tracing of the collected article (A).

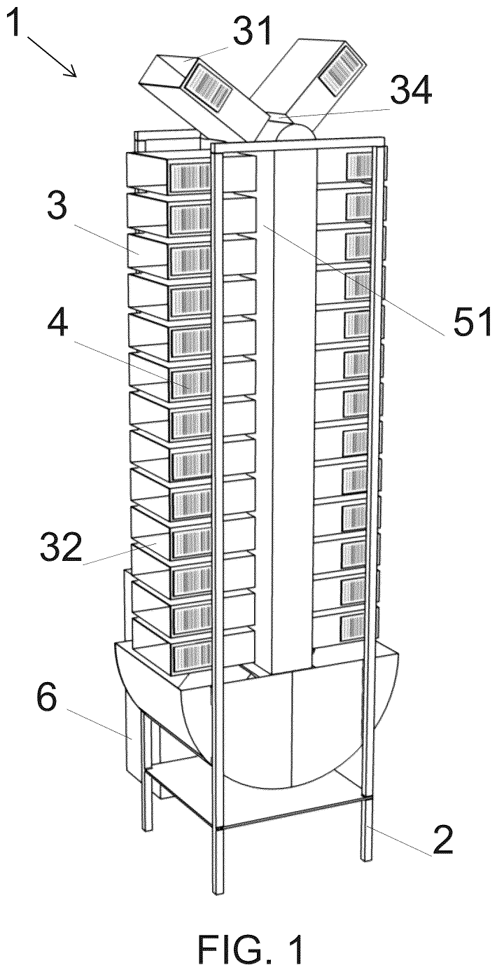

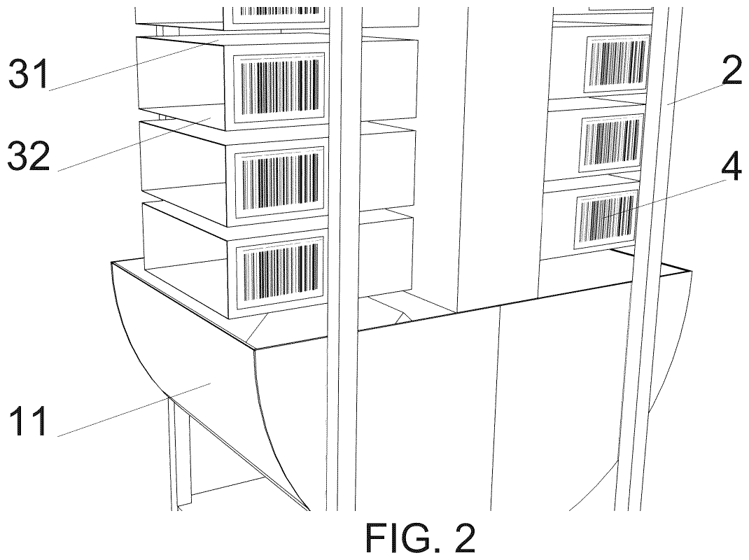

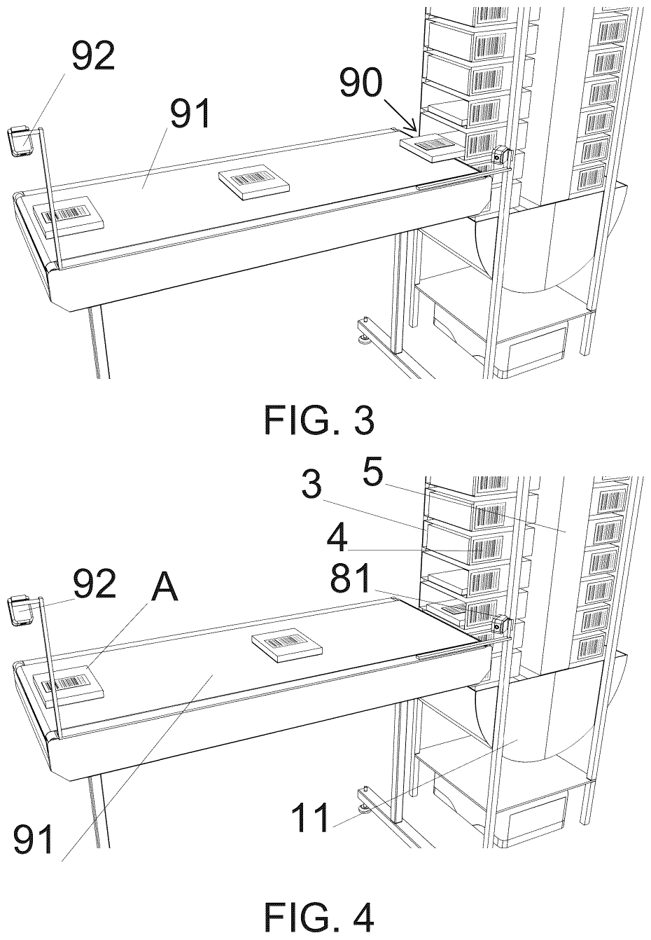

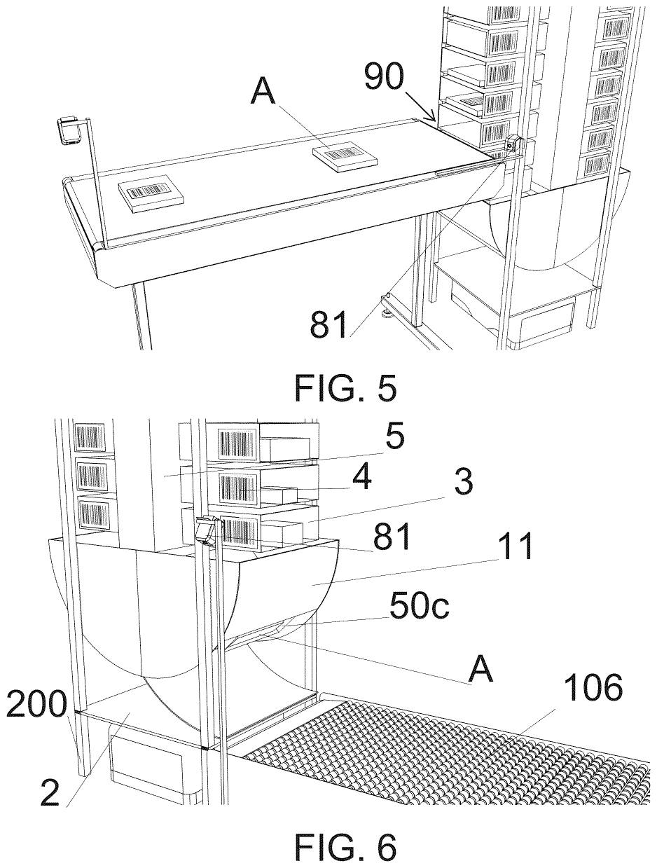

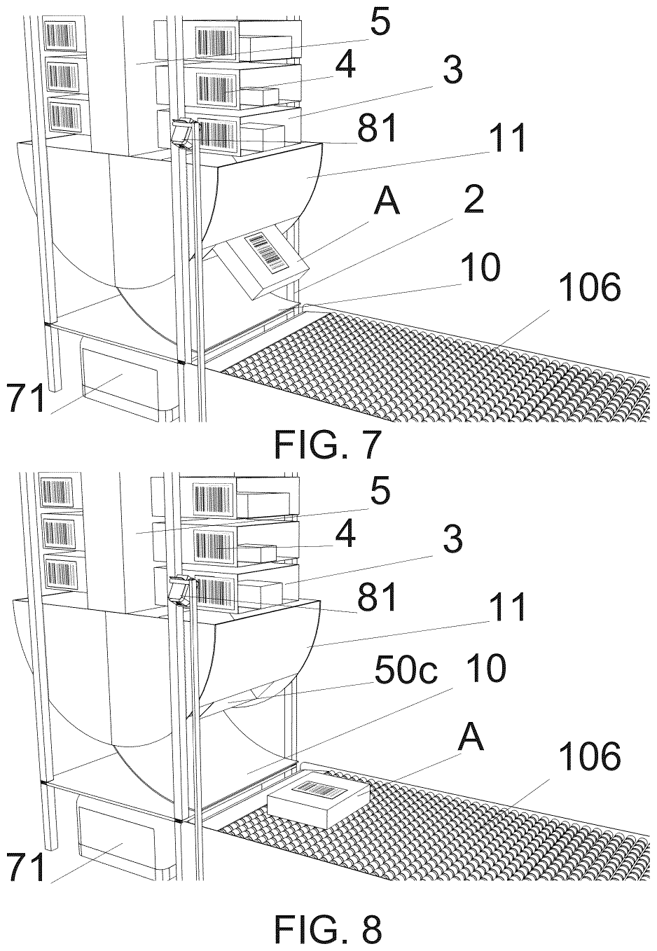

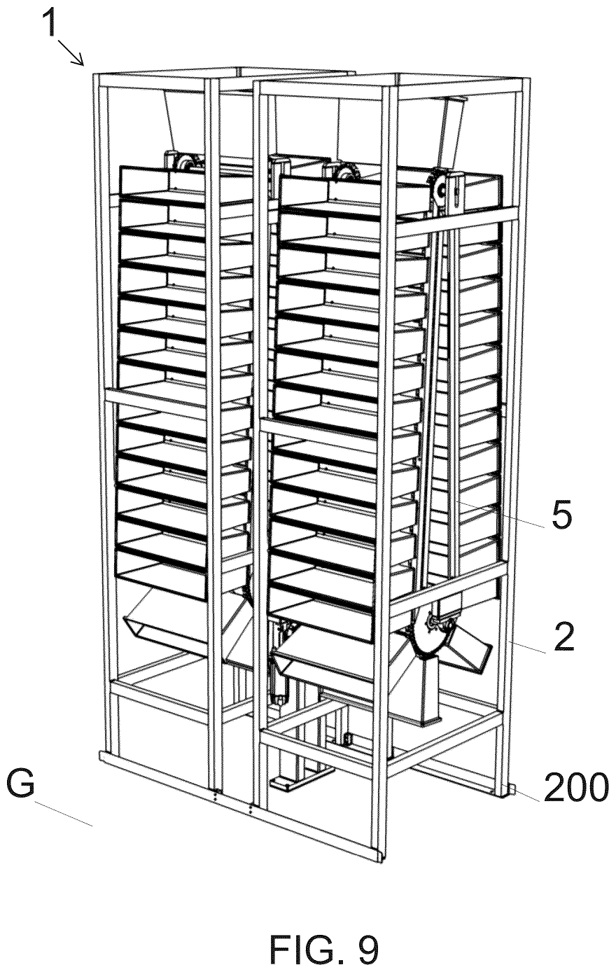

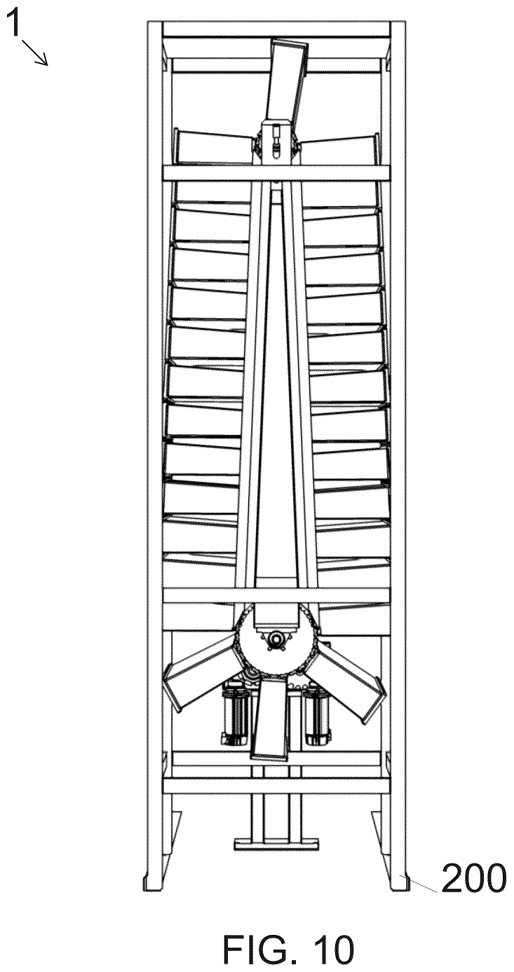

The identifier (4) can be, for example, a barcode, comprising two-dimensional barcodes or the data matrix, or a radio-frequency label or a sequence of characters. The identifier (4) can preferably be a barcode. The embodiment of FIG. 9 comprises a radio-frequency label (not visible in the figure) but might have a barcode as in the illustration in FIG. 1.

The closed looped pathway typically enables reducing the footprint on the ground surface and comprises an upper portion (50a), a lower portion (50b), a first portion (50d) which extends in a vertical direction and a second portion (50e) which extends in a vertical direction, with the upper portion (50a) and the lower portion (50b) both being interposed between the first portion (50d) and the second portion (50e). The storage unit of articles (1) facilitates automation of the operations of a store (100) and can be advantageously used in several steps of the process and/or areas of the store (100).

The articles (A) are stored in height, reducing the occupation of ground surface, and with a structure that enables good flexibility both when loading and collecting, as will be more fully clarified in the following.

The at least a storage unit of articles (1) can be self-moving or, more preferably, can be transported by displacement means external thereof; in both cases with the use of known devices.

In the case of a transportable storage unit of articles (1), the frame (2) preferably comprises rest feet (200) for resting on the ground surface (G); these are particularly useful as they provide, to the displacement means, a volume beneath the containers (3).

The displacement means preferably comprise at least an automatically-guided or autonomous vehicle (71). As is known to the technical expert in the field, a group of automatically-guided or autonomous vehicles (71) can move a plurality of storage units of articles (1) interchangeably and/or with the possibility of having a storage unit of articles (1) not associated to any automatically-guided or autonomous vehicle (71) for a period of time.

The displacement means move the frame (2) at least between a first spatial position and a second spatial position, and typically move the frame (2) among various points of a store (100).

In the case of a self-moving storage unit of articles (1), preferably this comprises drive wheels (73a).

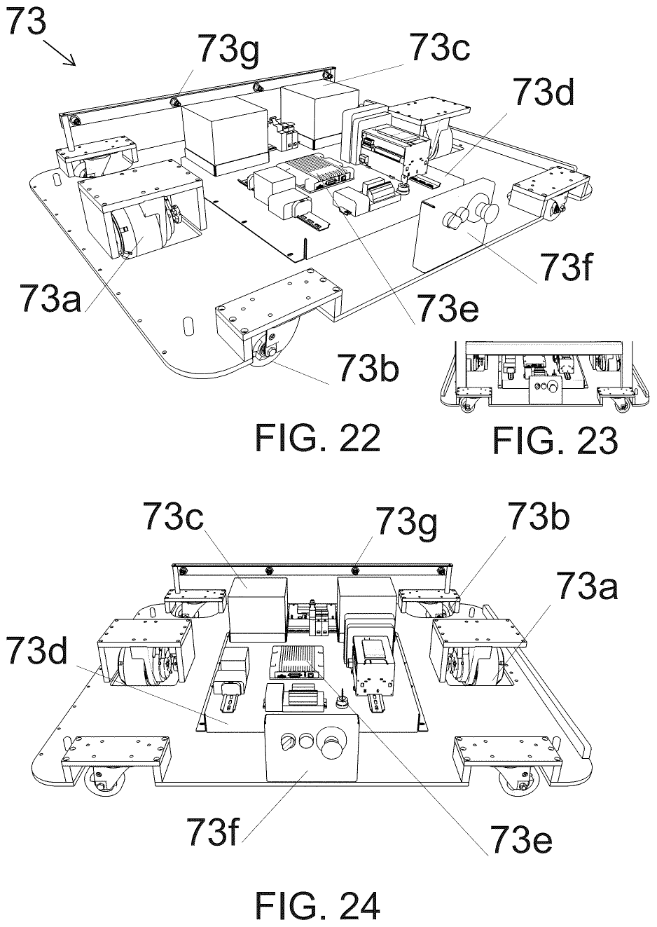

In a preferred embodiment the storage unit of articles (1) comprises a self-moving base (73) that comprises drive wheels (73a), a control unit (73d) which controls the drive wheels (73a) and a battery unit (73c) which powers the control unit (73d) and the drive wheels (73a). In FIGS. 22, 23 and 24 the self-moving base (73) also comprises pivoting wheels (73b), a navigation device (73e) functionally associated to the control unit (73d), a commands panel (73f), comprising a safety switch, and anti-collision sensors 73g).

In general the steps of recognising the articles (A) and placing the recognised articles (A) are at least in part simultaneous, as shown by way of example in FIGS. from 3 to 5.

Once the article (A) is in a collection point or area of the articles (50c), the step of collecting an article (A) is included: the article (A) can fall by force of gravity or be collected, for example by an anthropomorphic robot. “By force of gravity” means that the displacement towards the ground surface (G) takes place due to the gravitational force that acts on the article (A).

The method preferably comprises a step of providing a store management system (1000) which is configured so as to associate the identifier (4) of the container (3) to the placed article (A), receiving a request for a placed article (A), retrieving the identifier (4) associated to the requested article (A) and controlling the activation of the movement means (6).

The store management system (1000) is of known type and can be physical, virtual or mixed, for example in a cloud. By way of example, the store management system (1000) can comprise an application server and a data store. The server typically comprises one or more processing units or processors and at least a memory and is configured to carry out instructions. In general it also comprises a communication channel, a net interface, a graphic controller and input/output interfaces. The method preferably comprises a step of providing reading means for reading the identifiers (4) and a step of reading the identifier (4), both before the step of associating the identifier (4) of the container (3) to the placed article (A).

The reading means can read the identifier (4) before, during or after the article (A) has been placed in the container (3), for example taking account of the movement of the containers (3) which will be or which have been carried out.

The method preferably comprises steps of:
providing receptacles (104, 105), each for receiving articles (A) from the at least a storage unit of articles (1);
receiving an instruction to arrange a placed article (A) in a second receptacle (105);
retrieving the identifier (4) associated to the requested article (A) in the second receptacle (105);
displacing the at least a self-moving storage unit of articles (1) with the identifier (4) associated to a first receptacle (104) to the second receptacle (105);
activating the movement means (6) so as to bring the container (3) which carries the retrieved identifier (4) into a collection point or area of the articles (50c).

The method of the invention is advantageously applicable in a case of a plurality of receptacles (104, 105) such as, for example, in the case of sortering.

Once the article (A) is close to the second receptacle (105), the step of collecting an article (A) is included: the article (A) can fall by force of gravity in the second receptacle (105) or be placed, for example by an anthropomorphic robot.

The method preferably comprises a step of:
providing loading means for loading articles (A) into the containers (3) which have an unloading area of the articles (90).

In the step of placing the recognised articles (A) in the containers (3), the movement means (6) are activated so as to carry an empty container (3) into the unloading area of the articles (90).

The at least a storage unit of articles (1) enables facilitating and accelerating the loading of the articles (A).

Diverse approaches are possible. By way of example, according to a first approach the loading takes place when the container (3) is at a point or area of the first portion (50d) with the movement means (6) moving the containers in such a way that the loaded containers (3) are directed towards the second portion (50e) then to be unloaded at a point or area of the lower portion (50b) beneath the second portion (50e).

In a first embodiment, after the loading of the containers (3), the movement means (6) move the containers (3) in an opposite direction in order to be unloaded at a point or area of the lower portion (50b) beneath the first portion (50d).

The two variants can be combined so as to have two collection points or areas of the articles (50c).

Often, following the step of placing the articles in the containers (3), the step as follows can take place:
taking the storage unit of articles (1) to a storage area (103) of the at least a storage unit of articles (1).

According to the applications, the at least a storage unit of articles (1) can remain waiting in the storage area (103) for minutes or days.

In the typical case of a plurality of storage units of articles (1) the method can comprise steps of:
identifying a storage unit of articles (1) which stores the requested article (A);
displacing the identified storage unit of articles (1).

Preferably, during the step of displacing the identified storage unit of articles (1), the unit is moved from a storage area (103) of the at least a storage unit of articles (1).

The method is preferably realised with the devices that are better illustrated in the following.

The invention also relates to a store (100) of articles (A).

An embodiment of the store (100) comprises:
at least a storage unit of articles (1) comprising a frame (2), containers (3) for articles (A), an identifier (4) for each container (3) carried by the respective container (3);
loading means for loading articles (A) in the containers (3);
displacement means for displacing the at least a storage unit of articles (1);
a store management system (1000) comprising recognition means for recognising the articles (A) and/or the reading means for reading identifiers (4).

The store management system (1000) is configured to associate each article (A) to the identifier (4) of the container (3) that contains it and is of known type, already illustrated in the foregoing.

The at least a storage unit of articles (1) advantageously comprises a support system (5) of the containers (3) which supports the containers (3) so that they are movable with respect to the frame (2) according to a closed looped pathway. The store (100) comprises movement means (6) for moving the support system (5) so as to move the containers (3) with respect to the frame (2). The store management system (1000) controls the loading means and/or the movement means (6) and is configured in such a way that each container (3) contains at most one article (A).

In the store (100) of the invention the management of the articles (A) is facilitated due to the direct relation between the container (3) and the article (A) containing it, with the advantages illustrated in the foregoing. The positioning of the articles (A) in the containers (3) can be done following various logical systems. The store management system (1000) can manage the movement of the articles (A) towards the containers (3) and/or the movement of the containers (3). In FIGS. from 3 to 5, the loading means have a fixed velocity, for example because an operator loads the moved-away articles (A), and the store management system (1000) controls the movement of the containers (3). In other versions, the loading means might also be controlled on the basis of the availability of one or more free containers (3).

The displacement means displace the at least a storage unit of articles (1) at least between a first station (101) and a second station (102) or a storage area (103) of the at least a storage unit of articles (1).

There are numerous known devices which can have the function of recognition means. For example the recognition means can comprise a data entering device or input device, a first barcode reader (92), a recognition system with a camera and/or video camera, etc. The recognition means often comprise a plurality of devices, integrated in a portal or a station (101, 102). The recognition means preferably comprise a first optical barcode reader (92). The recognition means more preferably comprise mass detectors and/or size detectors of the articles (A).

The closed looped pathway typically enables reducing the footprint on the ground surface and comprises an upper portion (50a), a lower portion (50b), a first portion (50d) which extends in a vertical direction and a second portion (50e) which extends in a vertical direction, with the upper portion (50a) and the lower portion (50b) both being interposed between the first portion (50d) and the second portion (50e). Preferably the containers (3) have an opening (33) for entry and outlet of the articles (A) and the support system (5) of the containers (3) carries the containers (3) in such a way that the opening (33) is facing towards the ground surface (G) in at least a collection point or area of the articles (50c) so that the articles (A) exit from the container (3) by force of gravity. More preferably, the at least a collection point or area of the articles (50c) is in the lower portion (50b).

It is thus possible to automatically collect, in a simple way, the articles stored in the at least a storage unit of articles (1).

The at least a collection point or area of the articles (50c) is preferably lower than the point or area of the pathway where the loading means load the articles (A) into the containers (3).

Thus there is a further facilitation of the automatic collection and the store is simplified.

The store preferably comprises a door (10) for passage of the articles (A) which is in the at least a collection point or area of the articles (50c) and which is movable between a closed position, in which it prevents passage, and an open position, in which it allows passage. The store management system (1000) controls the movability of the door (10).

The presence of a door (10), for example on board the at least a storage unit of articles (1), enables determining which container or containers (3) will be uploaded with applicational advantages, for example in sortering.

The store (100) preferably comprises a first station (101) of the at least a storage unit of articles (1). Further:
the movement means (6) comprise motion transmission means installed at the first station (101) and configured so as to transmit the motion to the support system (5) when the at least a storage unit of articles (1) is in the first station (101) and/or
the reading means comprise a barcode reader (81), comprising two-dimensional barcodes, or a reader (81) of radio frequency tags installed at the first station (101).

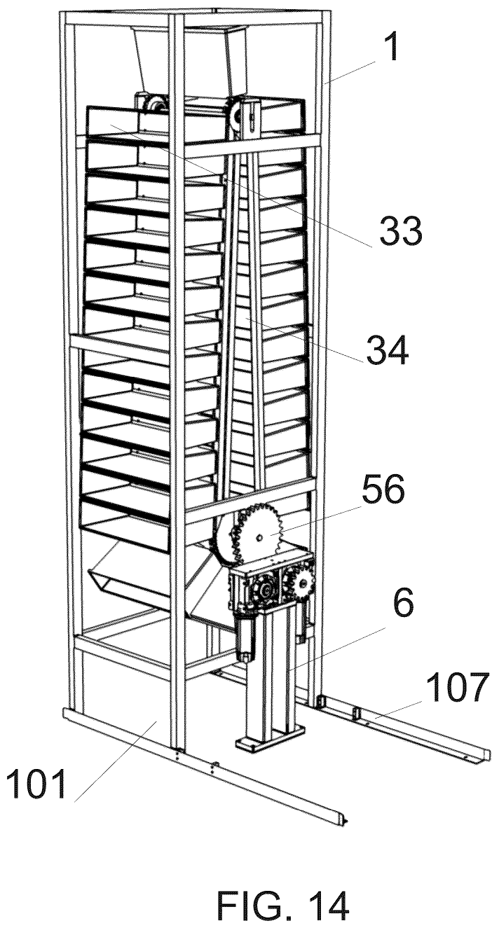

The first station (101) is typically used for the transfer of the articles (A). The availability of stations (101, 102), such as the one represented by way of example in FIG. 14, reduces the cost, the mass and the realisational and management complications of the storage unit of articles (1) with a minimum impact on the realising of the store (100).

The store (100) preferably comprises guides (107) installed at the first station (101) to guarantee the correct positioning of the storage unit of articles (1) and, possibly, of the motion transmission means. The movement means (6) preferably comprise at least a motor (61) which moves the motion transmission means and which is installed at the first station (101).

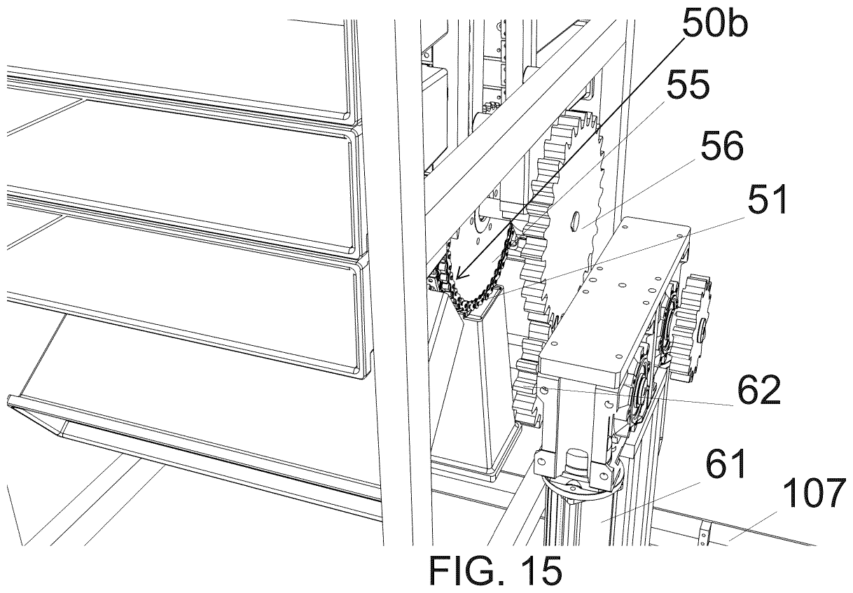

The motion transmission means preferably comprise a gearwheel (62) configured for coupling with the coupling means, in particular with the couplable gearing (56) visible in FIG. 15. The motion transmission means preferably also comprise a planetary gear.

The store (100) preferably comprises a transporter or conveyor (106) of articles (A) and a plurality of stations (101, 102) of the at least a storage unit of articles (1). The stations are arranged in succession at the position of the transporter or conveyor (106) so that the at least a self-moving storage unit of articles (1) places the articles (A) on the transporter or conveyor (106) when at a station of the plurality of stations (101, 102).

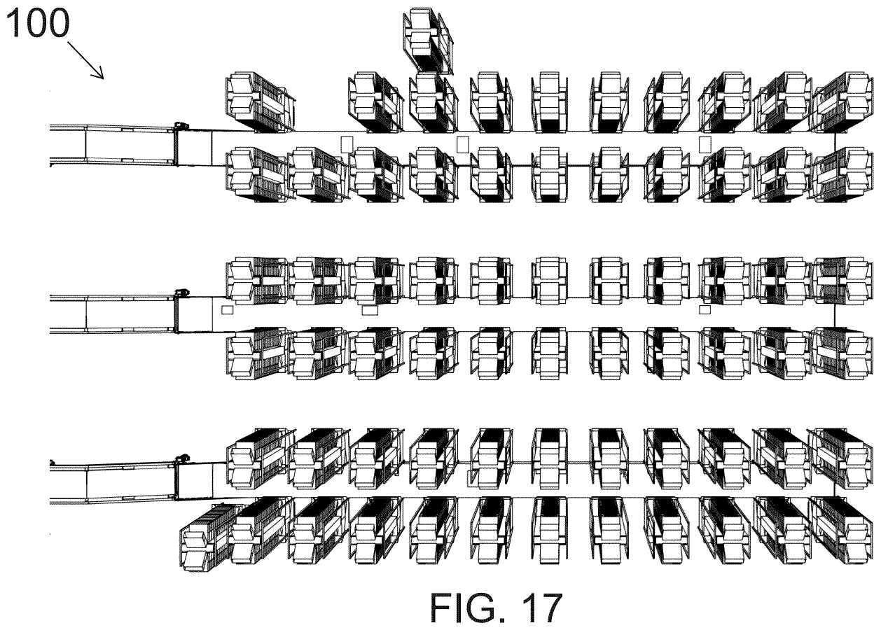

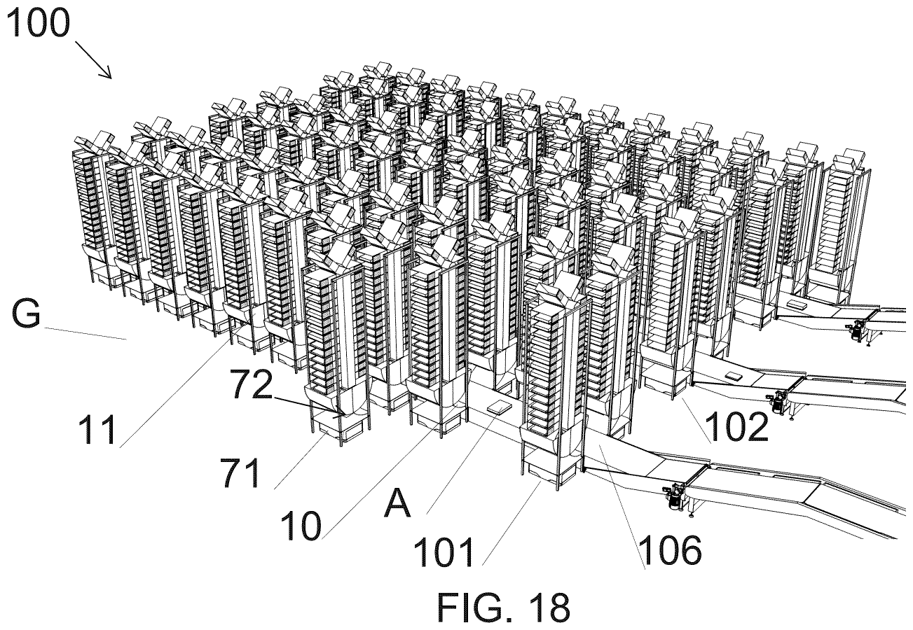

It is thus possible to make rapid and/or automated transfers of the articles (A) as is shown by way of example in FIGS. 17, 18 and 19. In FIGS. 17 and 18 the belt conveyors can carry the articles (A) to other areas in the store (100) of articles (A) or to several outlet points which have different destinations or activities.

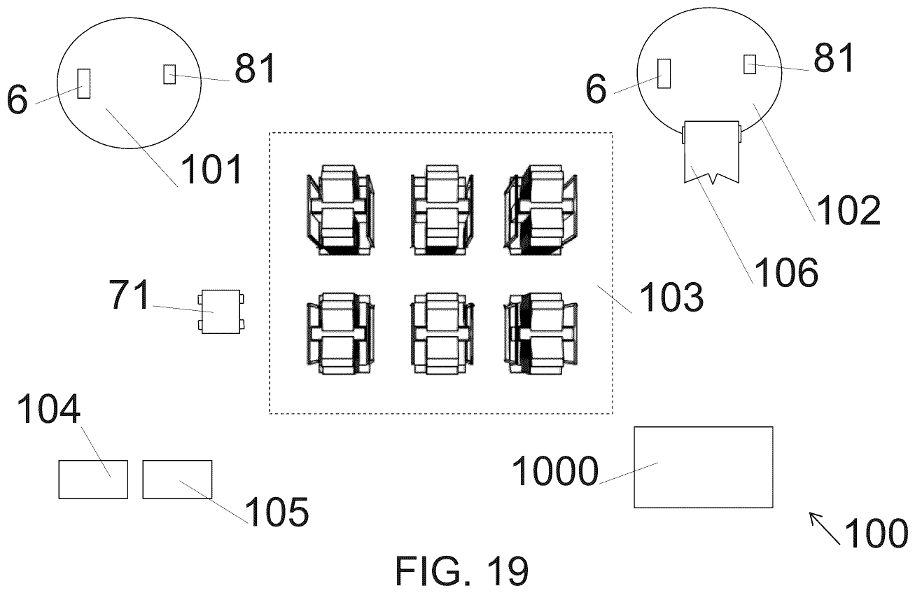

FIG. 19 illustrates an embodiment of the store (100) that is particularly complete, comprising a first station (101), a second station (102) with a transporter or conveyor (106), a storage area (103) of the at least a storage unit of articles (1), a store management system (1000) and a first receptacle (104) and a second receptacle (105).

FIGS. 17, 18 and 19 are illustrations by way of example of the invention in the case of a plurality of storage units of articles (1) according to the invention.

The preferred embodiments of the at least a storage unit of articles (1) illustrated above in relation to the method are clearly applicable inside the store (100).

Each container (3) preferably comprises a first part (31), a second part (32) and, between the first part (31) and the second part (32), an opening (33) for entry and outlet of the articles (A).

The support system (5) preferably supports the containers (3) in such a way that, or is configured so that:
a plurality of containers (3) are mutually overlapped in the first portion (50d) and a plurality of containers (3) are mutually overlapped in the second portion (50e);
each container has the first part (31) above the second part (32) in the first portion (50d), the second part (32) above the first part (31) in the second portion (50e), the opening (33) facing in a moving away direction from the containers (3) of the second portion (50e) in the first portion (50d) and the opening (33) facing towards the ground surface (G) in the lower portion (50b) so as to cause the fall of the articles (A) by force of gravity.

Further, the containers (3) and the pathway are configured in such a way that the second part (32) in the first portion (50d) and the first part (31) in the second portion (50e) are horizontal or inclined with respect to a horizontal plane (H) so as to prevent the falling of the articles (A).

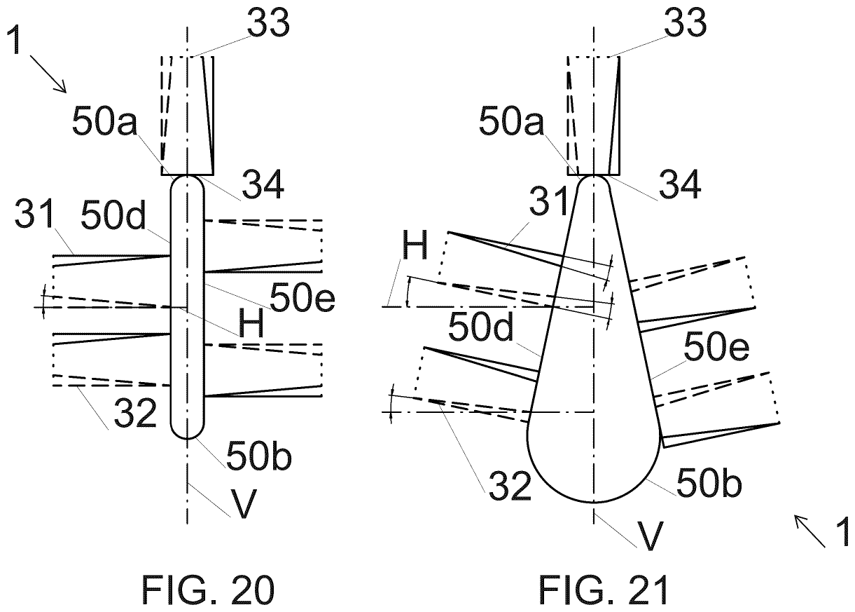

The expert in the sector will understand that there are numerous possible variants of the support system (5) which enable support of the containers (3) as described in the foregoing, i.e. with the use of different moving members with respect to the frame (2) and/or different couplings between the containers (3) and the same moving members. Purely by way of example, each single container (3) might be moved independently by a device along a guide or the containers (3) might be coupled to a same member or the containers (3) might be fixed with respect to the device or member or be movable with respect to one of the above. Also, FIGS. 20 and 21 schematically illustrate how it is possible to avoid the fall of articles (A) by acting on the shape of the containers (3) and/or on the pathway. In these figures, various lines are used to identify the first part (31) and the second part (32) with an indication of the angles of inclination with respect to a horizontal plane (H) and/or with respect to a container (3) with the first part (31) and the second part (32) being perpendicular to the pathway. FIG. 20 shows how the section of the container (3) can be reduced towards the opening (34) so as to prevent the falling of the articles (A). FIG. 21 shows how the inclination of the pathway might serve the same purpose.

Some preferred characteristics will be described in the following; FIGS. 1 and 9 show preferred embodiments which simplify the realisation and/or obtain further advantages.

As is clearly illustrated in the accompanying figures, the pathway is designed to stack articles (A) vertically, i.e. so as to have a large number of containers (3) in the first portion (50d) and in the second portion (50e).

It is specified that in the present description the expression “in the portion” is equivalent to “at the position of the portion”, i.e. it indicates the part of the pathway that is being crossed.

The opening (33) in the moving away direction simplifies the lateral loading and, more preferably, the support system (5) supports the containers (3) so that each container (3) in the second portion (50e) has the opening (33) facing in a moving away direction from the containers in the first portion (50d).

This characteristic is preferably obtained by making the container (3) solidly constrained to a part of a flexible organ (51, 52) of the support system (5) with the opening (33) facing in a moving away direction from the pathway.

The openings (33) in view on both sides enable greater control of the storage unit of articles (1), for example when the storage unit is paused in a storage area (103).

Preferably at least one, more preferably both, between the first portion (50d) and the second portion (50e) is perpendicular with respect to a horizontal plane (H), thus reducing the footprint on the ground surface as schematically illustrated in FIG. 20.

At least one from and preferably both, between the first portion (50d) and the second portion (50e) is preferably inclined with respect to a vertical plane (V) in such a way that the pathway broadens towards the lower portion (50b). In this case, especially in the case of containers (3) constrained to a part of a flexible organ (51, 52), the likelihood of articles (A) falling is reduced, as can be seen in FIG. 21.

Theoretically the configurations of FIGS. 20 and 21 can be combined, for example with a perpendicular first portion (50d) and an inclined second portion (50e).

An inclined portion makes the exiting of the articles (A) more difficult and/or enables using containers (3) having a section which broadens towards the opening (33). This possibility can be exploited to more easily realise the containers (3) by moulding and/or to limit the displacement of the articles (A) in the movement of the containers (3) given an equal opening (33).

The support system (5) preferably comprises at least a flexible organ (51, 52) to which the containers (3) are fixed so as to realise the closed looped pathway in a simple way.

More preferably, the at least a flexible organ (51, 52) is a chain or a band or a belt, in the broadest definition, i.e. comprising mesh belts, for example metal, slat, net or the like. As schematically illustrated in FIG. 1 the containers (3) might be directly fixed to the flexible organ (51) which might be a belt, as in the case of FIG. 1.

Other particularly effective and/or simple versions are however possible. As can be observed in the case of FIG. 9, the support system (5) preferably comprises a first flexible organ (51) with fittings (51a), a second flexible organ (52) with fittings (52a), positioned away from the first flexible organ (51), with the containers (3) fixed to the fittings (51a, 52b) of the first flexible organ (51) and the second flexible organ (52) directly or indirectly.

The support system (5) more preferably comprises connecting elements (53), and each connecting element (53) is fixed at least to a fitting (51a) of the first flexible organ (51), at least to a fitting (52a) of the second flexible organ (52) and to a respective container (3).

Each connecting element (53) is preferably fixed to the container (3) on the opposite side of the opening (33).

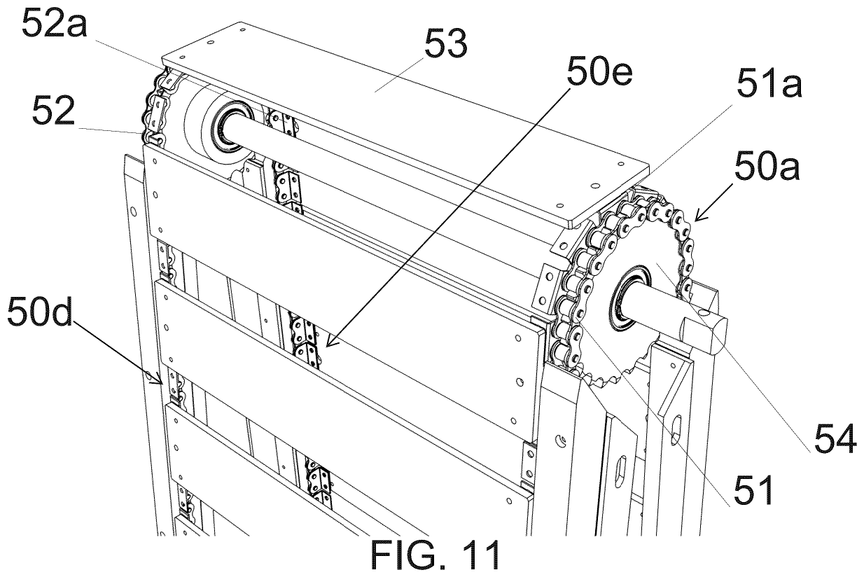

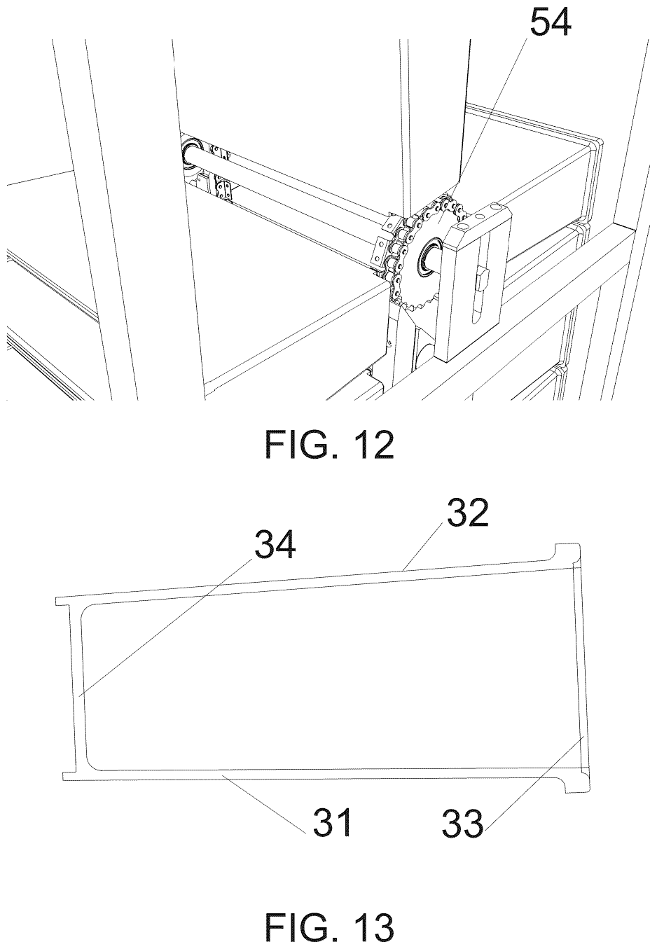

The at least a flexible organ (51, 52) with fittings can be, for example, a flexible organ with wings; preferably, though not necessarily, a chain with wings as illustrated in FIGS. 11 and 12.

Each container (3) preferably comprises a base (34), opposite the opening (33), from which the first part (31) and the second part (32) extend which are opposite one another with respect to the base (34). In this case is it preferable for the connecting element (53) to be fixed to the base (34). For example, in the case of FIG. 12 the connecting element (53) is housed at the base (34) between the protuberances that can be seen in FIG. 13.

In other versions the connecting element (53) and/or the at least a flexible organ (51, 52) might be used to oppose the exit of the articles (A).

The container (3) is preferably shaped as a pouch or basket.

The container (3) is preferably made by moulding and has the first part (31) and the second part (32) which broaden from the base (34) towards the opening (33) so as to facilitate moulding.

The foregoing has been a discussion of the advantages deriving, regardless of the particular embodiment, from a first part (31) and a second part (32) which broaden towards the opening (33), as illustrated by the internal lines of the containers schematically illustrated in FIG. 21.

The support system (5) preferably comprises a pulley or upper roller (54) and a pulley or lower roller (55) both rotatable with respect to the frame (2) and coupled to the at least a flexible organ (51, 52).

Typically the upper portion (50) corresponds to the engaging portion between the pulley or upper roller (54) and the at least a flexible organ (51, 52) and the lower portion (50b) corresponds to the engagement between the pulley or lower roller (55) and the at least a flexible organ (51, 52).

The pulley or upper roller (54) and the pulley or lower roller (55) preferably have rotation axes which lie on a same vertical plane (V), i.e. they are mutually superposed, and the pulley or upper roller (54) has a lower diameter of the pulley or lower roller (55) so that both the first portion (50d) and the second portion (50e) are inclined with respect to a vertical plane (V) in such a way that the pathway broadens towards the lower portion (50b), in a similar way to in FIG. 21.

The support system (5) preferably comprises coupling means for coupling the pulley or lower roller (55) or the pulley or upper roller (54), more preferably the pulley or lower roller (55), to distinct further movement means (6), i.e. external, of the storage unit of articles (1), so as to move the containers (3) with respect to the frame (2). Further, the coupling means comprise a couplable gearing (56). The couplable gearing (56) is preferably mounted on the axis of the pulley or lower roller (55) or the coupling means comprise a connecting shaft between them.

The movement means (6) might be borne by the frame (2), for example they might comprise a motor coupled to the or integrated in the pulley or lower roller (55), or a gear reducer. These configurations have a series of negative consequences; among which the greater empty mass of the storage unit of articles (1), the costs, the limited use in terms of time of the motor or the gear reducer.

The motor might also be borne by an automatically-guided vehicle or an autonomous vehicle (71), with impacts on the mass thereof, on the transportable mass and on the energy reserve.

The couplable gearing (56) can be configured, for example, so as to engage motion transmission means installed at a station (101, 102) for loading and/or collecting articles (A) or another means for transmission of the motion borne by the displacement means for displacing the storage unit of articles (1), for example an automatically-guided vehicle or an autonomous vehicle (71).

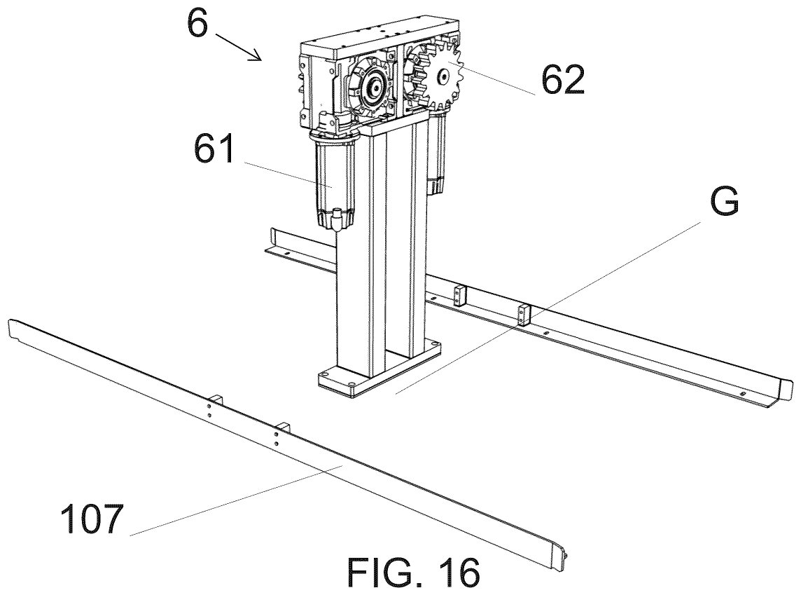

As can be observed in FIGS. 15 and 16, the couplable gearing (56) can be a gearwheel. In these figures, the motors (61) of the further movement means (6) can be seen.

The storage unit of articles (1) preferably comprises containment means (11) at the lower portion (50b) configured to oppose the exit of the articles (A) from the openings (33).

With the containment means (11) it is possible to determine, with greater precision, at least a collection point or area of the articles (50c). The containment means (11) are preferably solidly constrained to the frame (2). For example, the containment means (11) can comprise a part conformed like the pathway that prevents the exit of the articles (A). The containment means (11) can comprise or be coated with an anti-friction material towards the containers (3).

The containment means (11) preferably comprise one or more walls, for example realised using sheet steel or by moulding.

The storage unit of articles (1) preferably comprises the door (10), arranged in the lower portion (50b).

The door (10) is preferably made at the containment means (11), as is visible in FIG. 6.

The displacement means preferably comprise a device (72) configured to open or close the door (10). The device (72) can be, for example, an actuator of known type for vehicles having an automatic drive (71).

In combination or alternatively, the door (10) might be activated by an actuator of the storage unit of articles (1) or an actuator might be installed at the first station (101).

The loading means preferably comprise a transporter or conveyor, for example a belt conveyor (91), as can be seen in FIG. 3.

It is understood that the above has been described by way of non-limiting example and that any constructional variants are considered to fall within the protective scope of the present technical solution, as claimed in the following.

1. A method for collecting articles in a store comprising steps of:
providing at least a storage unit of articles comprising a frame, containers for articles, an identifier for each container which is borne by the respective container and a support system of the containers which supports the containers so that they are movable with respect to the frame according to a closed looped pathway which has at least a collection point or area of the articles;
providing movement means for moving the support system so as to move the containers with respect to the frame;
providing displacement means for displacing the at least a storage unit of articles;
providing articles;
recognising the articles;
placing the recognised articles in the containers, placing at most one article for each container;
associating the identifier of the container to the placed article;
receiving a request for a placed article;
retrieving the identifier associated to the requested article;
activating the movement means so as to bring the container which bears the retrieved identifier to a collection point or area of the articles.

2. The method of claim 1, comprising a step of providing a store management system which is configured so as to associate the identifier of the container to the placed article , receiving a request for a placed article, retrieving the identifier associated to the requested article (A) and controlling the activation of the movement means.

3. The method of claim 1, comprising a step of providing reading means for reading the identifiers and a step of reading the identifier, both before the step of associating the identifier of the container to the placed article.

4. The method of claim 1, comprising steps of:
providing receptacles, each for receiving articles from the at least a storage unit of articles;
receiving an instruction to arrange a placed article in a second receptacle;
retrieving the identifier associated to the requested article in the second receptacle;
displacing the at least a storage unit of articles with the associated identifier from a first receptacle to the second receptacle;
activating the movement means so as to bring the container which bears the retrieved identifier to a collection point or area of the articles.

5. The method of claim 1, comprising a step of:
providing loading means for loading articles into the containers which have an unloading area of the articles;
wherein in the step of placing the recognised articles in the containers, the movement means are activated so as to carry an empty container into the unloading area of the articles.

6. A store of articles comprising:
at least a storage unit of articles comprising a frame, containers for articles and an identifier for each container which is borne by the respective container;
loading means for loading articles into the containers;
displacement means for displacing the at least a storage unit of articles;
a store management system comprising recognition means for recognising the articles and reading means for reading the identifiers;
wherein the store management system is configured to associate each article to the identifier of the container which contains it, wherein
the at least a storage unit of articles comprises a support system of the containers which supports the containers in such a way that the containers are movable with respect to the frame according to a closed looped pathway;
the store comprises movement means for moving the support system so as to move the containers with respect to the frame;
the store management system controls the loading means and/or the movement means and is configured in such a way that each container contains at most one article.

7. The store of claim 6, wherein the containers have an opening for entry and outlet of the articles and wherein the support system of the containers carries the containers in such a way that the opening is facing towards the ground surface in at least a collection point or area of the articles so that the articles exit from the container by force of gravity.

8. The store of the claim 7, wherein the at least a collection point or area of the articles is lower than the point or area of the pathway where the loading means load the articles into the containers.

9. The store of claim 7, comprising a door for passage of the articles which is in the at least a collection point or area of the articles and which is movable between a closed position, in which it prevents passage, and an open position, in which it allows passage and wherein the store management system controls the movability of the door.

10. The store claim 6, comprising a first station of the at least a storage unit of articles wherein:
the movement means comprise drive transmission means installed at the first station and configured so as to transmit the motion to the support system when a storage unit of articles is in the first station and/or
the reading means comprise a reader of barcodes, comprising two-dimensional barcodes, or a reader of radio frequency tags installed at the first station (101).

11. The store of claim 6, comprising a transporter or conveyor of articles and a plurality of stations of the at least a storage unit of articles arranged in succession at the transporter or conveyor so that the at least a storage unit of articles places the articles on the transporter or conveyor when at a station of the plurality of stations.

1.) The method of claim 2, comprising steps of:
providing receptacles, each for receiving articles from the at least a storage unit of articles;
receiving an instruction to arrange a placed article in a second receptacle;
retrieving the identifier associated to the requested article in the second receptacle;
displacing the at least a storage unit of articles with the associated identifier from a first receptacle to the second receptacle;
activating the movement mean so as to bring the container which bears the retrieved identifier to a collection point or area of the articles.

13. The method of claim 2, comprising a step of providing reading means for reading the identifiers and a step of reading the identifier, both before the step of associating the identifier of the container to the placed article.

14. The method of claim 13, comprising steps of:
providing receptacles, each for receiving articles from the at least a storage unit of articles;
receiving an instruction to arrange a placed article in a second receptacle;
retrieving the identifier associated to the requested article in the second receptacle;
displacing the at least a storage unit of articles with the associated identifier from a first receptacle to the second receptacle;
activating the movement mean so as to bring the container which bears the retrieved identifier to a collection point or area of the articles.

15. The method of claim 3, comprising steps of:
providing receptacles, each for receiving articles from the at least a storage unit of articles;
receiving an instruction to arrange a placed article in a second receptacle;
retrieving the identifier associated to the requested article in the second receptacle;
displacing the at least a storage unit of articles with the associated identifier from a first receptacle to the second receptacle;
activating the movement mean so as to bring the container which bears the retrieved identifier to a collection point or area of the articles.

16. The store of claim 7, comprising a first station of the at least a storage unit of articles wherein:
the movement means comprise drive transmission means installed at the first station and configured so as to transmit the motion to the support system when a storage unit of articles is in the first station and/or
the reading means comprise a reader of barcodes, comprising two-dimensional barcodes, or a reader of radio frequency tags installed at the first station.

17. The store of claim 7, comprising a transporter or conveyor of articles and a plurality of stations of the at least a storage unit of articles arranged in succession at the transporter or conveyor so that the at least a storage unit of articles places the articles on the transporter or conveyor when at a station of the plurality of stations.

18. The store of claim 8, comprising a door for passage of the articles which is in the at least a collection point or area of the articles and which is movable between a closed position, in which it prevents passage, and an open position, in which it allows passage and wherein the store management system controls the movability of the door.
